(19) United States
(12) Patent Application Publication
(10) Pub. No.: US 2006/0131854 A1
(43) Pub. Date: Jun. 22, 2006

(54) Airbag device

(75) Inventors: Daiei Tonooka, Utsunomiya-shi (JP); Takeshi Kai, Utsunomiya-shi (JP)

Correspondence Address: RANKIN, HILL, PORTER & CLARK LLP, 4080 ERIE STREET, WILLOUGHBY, OH, 44094-7836, US

(73) Assignee: Honda Motor Co., Ltd., Tokyo (JP)

(21) Appl. No.: 11/299,247

(22) Filed: Dec. 9, 2005

(30) Foreign Application Priority Data
Dec. 17, 2004 (JP) 2004-366112

(51) Int. Cl. B60R 21/26

(52) U.S. Cl. 280/740; 280/742

(57) ABSTRACT

An airbag device comprises an inflator which generates a pressure by means of a fluid; an airbag which expands by the pressure from said inflator; and an inlet pipe which communicates between said inflator and said airbag, wherein said inlet pipe comprises: a straight portion having an approximately equal inner diameter; a throat portion provided on the downstream side of said straight portion and having an inner diameter decreased towards the downstream; and a diffuser portion provided on the downstream side of said throat portion and having an inner diameter increased towards the downstream so as to become approximately the same as the inner diameter of said straight portion.

### BACKGROUND OF THE INVENTION

1. Field of the Invention

The present invention relates to an airbag device for protecting occupants at the time of a vehicle collision.

Priority is claimed on Japanese Patent Application No. 2004-366112, filed Dec. 17, 2004, the content of which is incorporated herein by reference.

2. Description of the Related Art

An airbag device provided in a vehicle for protecting occupants at the time of a vehicle collision has; an inflator which generates a pressure by means of a fluid, an airbag which expands by the fluid pressure generated from the inflator, and an inlet pipe which communicates between the inflator and the airbag. For the inlet pipe of the airbag device, normally one with an approximately equal inner diameter is used.

Meanwhile, there is disclosed a technique wherein a gas passage inside of the inflator is provided with a straight portion, a diameter decreasing portion, and a diameter increasing portion (Japanese Utility Model Registration No. 3041005, p. 17, FIG. 3).

However, if the inside of the inflator is provided with such a straight portion, a diameter decreasing portion, and a diameter increasing portion, the gas flow becomes unstable within the inflator because inflator is the source of the inflation gas, causing a problem in that the effect thereof is not sufficiently demonstrated. Moreover, if the inside of the inflator is provided with a straight portion, a diameter decreasing portion, and a diameter increasing portion, the inflator loses general versatility, causing another problem of increasing the cost because the structure of the inflator becomes complex.

Therefore, an object of the present invention is to provide an airbag device in which the effect by modifying the passage shape can be sufficiently demonstrated, and further the cost can be decreased.

### SUMMARY OF THE INVENTION

In order to achieve the above object, a first aspect of the present invention is an airbag device comprising: an inflator which generates a pressure by means of a fluid; an airbag which expands by the pressure from the inflator; and an inlet pipe which communicates between the inflator and the airbag. The inlet pipe has a straight portion having an approximately equal inner diameter, a throat portion provided on the downstream side of the straight portion and having an inner diameter decreased towards the downstream, and a diffuser portion provided on the downstream side of the throat portion and having an inner diameter increased towards the downstream so as to become approximately the same as the inner diameter of the straight portion.

According to the first aspect of the present invention, since the inlet pipe has the straight portion having an approximately equal inner diameter, the throat portion provided on the downstream side and having the inner diameter decreased towards the downstream side; and the diffuser portion provided on the downstream side and having an inner diameter increased towards the downstream side so as to become approximately the same as the inner diameter of the straight portion, then an inlet pipe through which the fluid flow is relatively stable is modified in such a passage shape. Therefore, the flow velocity at the beginning of the inflation of the airbag can be decreased, and the load on the airbag can be decreased. Moreover, since the flow velocity and/or the flow rate can be increased thereafter, an effect, such as being able to inflate the airbag in a short time, can be reliably obtained. Furthermore, since the inflator can have general versatility, the cost can be decreased.

### BRIEF DESCRIPTION OF THE DRAWINGS

FIG. 1 is a plan view showing the interior of a vehicle provided with an airbag device of a first embodiment of the present invention;

FIG. 2 is a schematic diagram of the airbag device of the first embodiment of the present invention;

FIG. 3 is a cross-sectional view of an inlet pipe of the airbag device of the first embodiment of the present invention;

FIG. 4 is a characteristic chart showing the volume and the volumetric efficiency at the inflow border and at the outflow border of the nozzle of the airbag device of the first embodiment of the present invention, and of a straight nozzle; and

FIG. 5 is a characteristic chart of relative error of the nozzle of the airbag device of the first embodiment of the present invention, with respect to a straight nozzle.

### DESCRIPTION OF THE PREFERRED EMBODIMENTS

Hereinafter is a description of an airbag device of a first embodiment of the present invention, with reference to drawings.

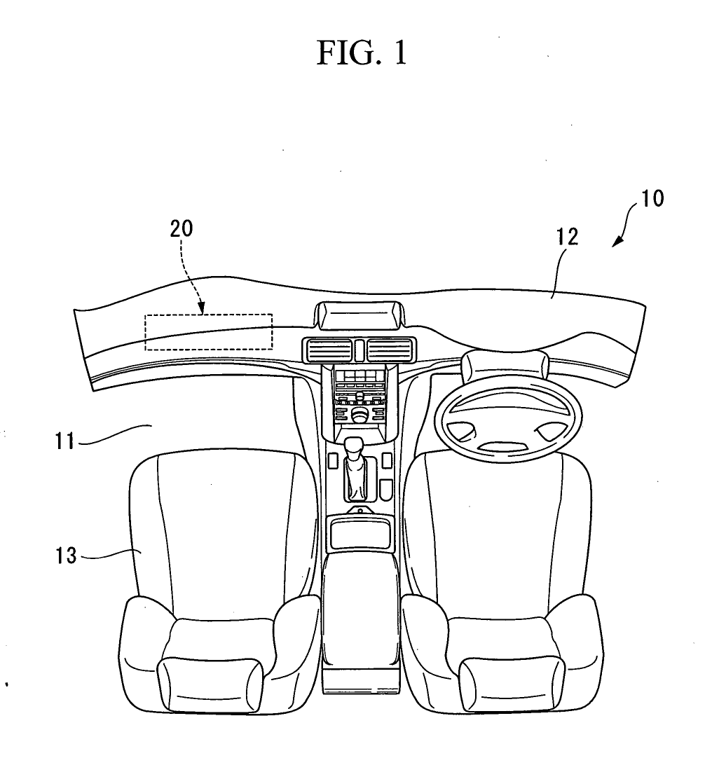

FIG. 1 illustrates an interior 11 of a vehicle 10, provided with an airbag device 20 of the present invention, on the passenger seat 13 side in the vehicle widthwise direction, of an instrument panel 12. In addition to the above arrangement, the airbag device 20 of the present embodiment is applicable to all types of airbag device provided in the vehicle 10, such as a curtain airbag device provided on a pillar.

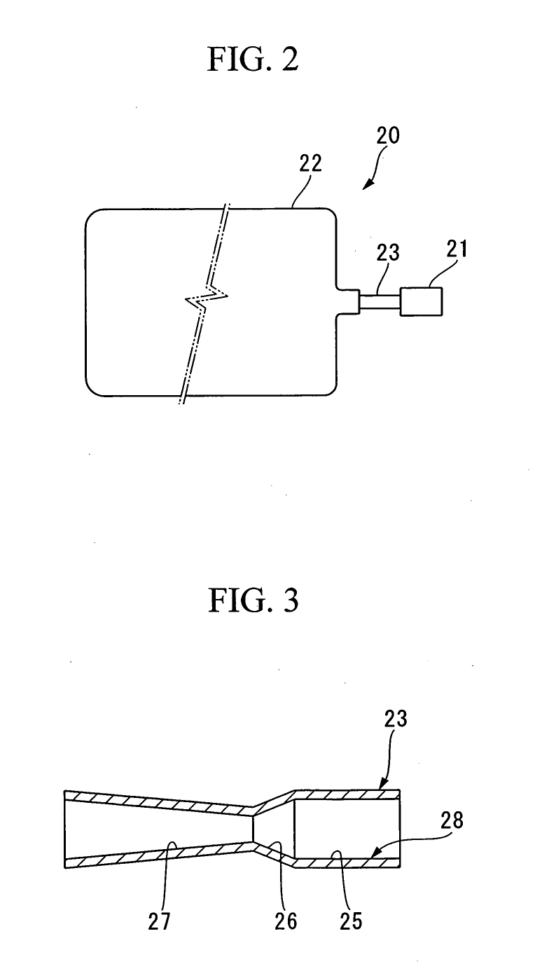

FIG. 2 shows a structure of the airbag device 20 of the present embodiment, comprising: an inflator 21 which generates a pressure by means of gas (fluid); an airbag 22 which expands by the pressure from the inflator 21; and an inlet pipe 23 which communicates between the inflator 21 and the airbag 22.

In the present embodiment, as shown in FIG. 3, the inlet pipe 23 has a nozzle 28 comprising: a straight portion 25; a throat portion 26 provided adjacent to the downstream side of the straight portion 25; and a diffuser portion 27 provided adjacent to the downstream side of the throat portion 26. The basic diameter of the inlet pipe 23 is constant.

The straight portion 25 has a circular cross-section shape with an approximately equal inner diameter throughout.

The throat portion 26 is provided on the same axis as the straight portion 25, and has a circular cross-section in a tapered shape where the diameter on the downstream side, that is the diffuser portion 27 side, is decreased. The inner diameter of the end of the throat portion 26 on the straight portion 25 side is the same as the inner diameter of the straight portion 25, and it is connected to the straight portion 25.

The diffuser portion 27 is provided on the same axis as the straight portion 25 and the throat portion 26, and has a circular cross-section in a tapered shape where the diameter on the downstream side, that is the side opposite to the throat portion 26, is increased. The inner diameter of the end of the diffuser portion 27 on the throat portion 26 side is the same as the minimum inner diameter of the throat portion 26, and it is connected to the throat portion 26. Moreover, the inner diameter of the other end of the diffuser portion 27 opposite to the throat portion 26 side is the same as the inner diameter of the straight portion 25.

By using such an inlet pipe 23 having a nozzle 28 comprising: the straight portion 25 having an approximately equal inner diameter; the throat portion 26 provided on the downstream side, and having the inner diameter decreased towards the downstream side; and the diffuser portion 27 provided on the downstream side, and having the inner diameter increased towards the downstream side so as to become approximately the same as the inner diameter of the straight portion 25, then an inlet pipe 23 through which the gas flow is relatively stable is modified in such a passage shape. Therefore, the flow velocity at the beginning of the inflation of the airbag 22 can be decreased, and the load on the airbag 22 can be decreased. Moreover, since the flow velocity and the flow rate can be increased thereafter, an effect, such as being able to inflate the airbag 22 in a short time, can be reliably obtained. Furthermore, since the inflator 21 can have general versatility, the cost can be decreased.

Next is a further description of the nozzle 28 (hereinafter, referred to as a turbo nozzle) of the present embodiment, having the straight portion 25, the throat portion 26, and the diffuser portion 27, compared to a straight nozzle having a equal inner diameter.

Firstly, physical reference symbols used for the description are shown hereinafter.

A: flow passage area of nozzle [m²]

V_{IN}: velocity of fluid at inflow border [m/s]

V_{OUT}: velocity of fluid at outflow border [m/s]

ρ_{IN}: density of fluid at inflow border [kg/m³]

ρ_{OUT}: density of fluid at outflow border [kg/m³]

p: static pressure of fluid flowing in nozzle [Pa]

ρ: density of fluid flowing in nozzle [kg/m³]

T: temperature of fluid flowing in nozzle [K]

a: sonic speed of fluid flowing in nozzle [m/s]

M: Mach number

κ: specific heat ratio of fluid flowing in nozzle

m_{IN}: mass flow rate at inflow border [kg/s]

m_{OUT}: mass flow rate at outflow border [kg/s]

C: arbitrary constant

s: entropy [J/K]

Q: heat quantity [J]

η_{T}_{_{B}}: volumetric efficiency with respect to turbo nozzle

η_{ST}: volumetric efficiency with respect to straight nozzle

If the flow in a nozzle is assumed to be isoentropic flow, a fluid flowing in the nozzle can not exceed the sonic speed of the fluid. However, by providing a throat portion and a diffuser portion, a supersonic flow can be obtained. This is generally realized under certain conditions. That is, a supersonic flow is realized when the static pressure at the outflow border of the diffuser portion, and the pressure of the surrounding medium (air) are equal. Here, isoentropic flow means reversible flow that is adiabatic flow without any friction. Since this is flow with no entropy change, there is no energy transfer nor loss in the fluid flowing in the nozzle.

The following equations are fundamental equations regarding one-dimensional flow, assuming that the flow in the nozzle is isoentropic flow.
Equation of Continuity

$$\frac{d ρ}{ρ} + \frac{d A}{A} + \frac{d V}{V} = 0 \qquad ( 1 )$$

Equation of Motion

$$VdV + \frac{1}{ρ} dp = 0 \qquad ( 2 )$$

Equation of Isoentropy

$$\frac{dp}{p} - κ \frac{dp}{p} = 0 \qquad ( 3 )$$

Equation of Gas State

$$\frac{d p}{p} = \frac{d ρ}{ρ} + \frac{d T}{T} \qquad ( 4 )$$

Equation of Sonic Speed

$${a}^{2} = \frac{d p}{d ρ} \qquad ( 5 )$$

Relational expressions for the physical quantities with respect to supersonic flow are made.

Equation (5) is substituted into equation (2).

$$VdV = - \frac{d p}{d ρ} \frac{d ρ}{ρ} = - \frac{d ρ}{ρ} {a}^{2} \\ \frac{{V}^{2}}{{a}^{2}} \frac{dV}{V} = - \frac{d ρ}{ρ} ⇒ {M}^{2} \frac{dV}{V} = - \frac{d ρ}{ρ} [ M = \frac{V}{a} ; Mach Number ] \\ \frac{d ρ}{ρ} = - {M}^{2} \frac{dV}{V} \qquad ( 6 )$$

Equation (6) is substituted into equation (1) so as to derive a relational expression for the change in the velocity of the fluid and the change in the area of the nozzle.

$$\frac{d ρ}{ρ} + \frac{dA}{A} + \frac{dV}{V} = 0 ⇒ - {M}^{2} \frac{dV}{V} + \frac{dA}{A} + \frac{dV}{V} = 0 \\ \frac{dV}{V} ( 1 - {M}^{2} ) + \frac{dA}{A} = 0 \\ \frac{dV}{V} = \frac{1}{{M}^{2} - 1} \frac{dA}{A} \qquad ( 7 )$$

Equation (6) is substituted into equation (1) so as to derive a relational expression for the change in the density of the fluid and the change in the area of the nozzle.

$$\frac{d ρ}{ρ} + \frac{dA}{A} + \frac{dV}{V} = 0 ⇒ \frac{d ρ}{ρ} + \frac{dA}{A} + - \frac{1}{{M}^{2}} \frac{d ρ}{ρ} = 0 \frac{d ρ}{ρ} ( 1 - \frac{1}{{M}^{2}} ) + \frac{dA}{A} = 0 \\ \frac{{M}^{2} - 1}{{M}^{2}} \frac{d ρ}{ρ} + \frac{dA}{A} = 0 \\ \frac{d ρ}{ρ} = ( \frac{{M}^{2}}{1 - {M}^{2}} ) \frac{dA}{A} \qquad ( 8 )$$

Equation (8) is substituted into equation (3) so as to derive a relational expression for the change in the static pressure of the fluid and the change in the area of the nozzle.

$$\frac{d p}{p} - κ \frac{d ρ}{ρ} = 0 ⇒ \frac{d p}{p} - κ ( \frac{{M}^{2}}{1 - {M}^{2}} ) \frac{dA}{A} = 0 \\ \frac{d p}{p} = κ ( \frac{{M}^{2}}{1 - {M}^{2}} ) \frac{d A}{A} \qquad ( 9 )$$

Equation (8) and equation (9) are substituted into equation (4) so as to derive a relational expression for the change in the temperature of the fluid and the change in the area of the nozzle.

$$\frac{d p}{p} = \frac{d ρ}{ρ} + \frac{d T}{T} \\ \begin{matrix}\frac{d T}{T} = κ ( \frac{{M}^{2}}{1 - {M}^{2}} ) \frac{d A}{A} - ( \frac{{M}^{2}}{1 - {M}^{2}} ) \frac{d A}{A} \\ = ( κ - 1 ) \frac{{M}^{2}}{1 - {M}^{2}} \frac{d A}{A}\end{matrix} \qquad ( 10 )$$

The relational expressions for the physical quantities with respect to supersonic flow are obtained as the following four equations.

A relational expression for the change in the velocity of the fluid and the change in the area of the nozzle is as follows:

$$\frac{dV}{V} = \frac{1}{{M}^{2} - 1} \frac{dA}{A} \qquad ( 11 )$$

A relational expression for the change in the density of the fluid and the change in the area of the nozzle is as follows:

$$\frac{d ρ}{ρ} = ( \frac{{M}^{2}}{1 - {M}^{2}} ) \frac{dA}{A} \qquad ( 12 )$$

A relational expression for the change in the static pressure of the fluid and the change in the area of the nozzle is as follows:

$$\frac{d p}{p} = κ ( \frac{{M}^{2}}{1 - {M}^{2}} ) \frac{dA}{A} \qquad ( 13 )$$

A relational expression for the change in the temperature of the fluid and the change in the area of the nozzle is as follows:

$$\frac{dT}{T} = ( κ - 1 ) \frac{{M}^{2}}{1 - {M}^{2}} \frac{dA}{A} \qquad ( 14 )$$

Next is a description of a qualitative relationship of the physical quantities with respect to the nozzle shape.

The relationship between the change in the velocity of the fluid and the change in the area of the nozzle is as in the following Table 1. In Table 1, there is shown a straight nozzle on the left, a nozzle that broadens the diameter thereof toward the end in the middle, and nozzle that diminishes the diameter thereof toward the end on the right, and the relationships between the change in the velocity of the fluid and the change in the cross-sectional area of the nozzle are shown respectively.

TABLE 1

| | 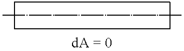 | 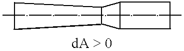 | 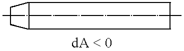 |
|---|---|---|---|
| M < 1 | $\frac{dV}{V} = 0$ | $\frac{dV}{V} = - C \frac{dA}{A} ∴ \frac{dV}{dA} = - C \frac{V}{A}$ | $\frac{dV}{V} = C \frac{dA}{A} ∴ \frac{dV}{dA} = C \frac{V}{A}$ |
| | NO CHANGE IN | DECREASE IN | INCREASE IN |
| | VELOCITY | VELOCITY | VELOCITY |
| M > 1 | INVALID | $\frac{dV}{V} = C \frac{dA}{A} ∴ \frac{dV}{dA} = C \frac{V}{A}$ | $\frac{dV}{V} = - C \frac{dA}{A} ∴ \frac{dV}{dA} = - C \frac{V}{A}$ |
| | | INCREASE IN | DECREASE IN |
| | | VELOCITY | VELOCITY |

The relationship between the change in the density of the fluid and the change in the area of the nozzle is as in the following Table 2. In Table 2, there is shown a straight nozzle on the left, a nozzle that broadens the diameter thereof toward the end in the middle, and nozzle that diminishes the diameter thereof toward the end on the right, and the relationships between the change in the density of the fluid and the change in the cross-sectional area of the nozzle are shown respectively.

TABLE 2

| | 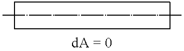 | 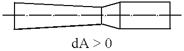 | 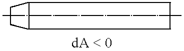 |
|---|---|---|---|
| M < $\frac{d ρ}{ρ} = 0$ | $\frac{dρ}{ρ} = C \frac{dA}{A} ∴ \frac{dρ}{dA} = C \frac{ρ}{A}$ | $\frac{dρ}{ρ} = - C \frac{dA}{A} ∴ \frac{dρ}{dA} = - C \frac{ρ}{A}$ | |
| | NO CHANGE IN | INCREASE IN | DECREASE IN |
| | DENSITY | DENSITY | DENSITY |
| M > 1 | INVALID | $\frac{dρ}{ρ} = - C \frac{dA}{A} ∴ \frac{dρ}{dA} = - C \frac{V}{ρ}$ | $\frac{dρ}{ρ} = - C \frac{dA}{A} ∴ \frac{dρ}{dA} = - C \frac{ρ}{A}$ |
| | | DECREASE IN | INCREASE IN |
| | | DENSITY | DENSITY |

The relationship between the change in the static pressure of the fluid and the change in the area of the nozzle is as in the following Table 3. In Table 3, there is shown a straight nozzle on the left, a nozzle that broadens the diameter thereof toward the end in the middle, and nozzle that diminishes the diameter thereof toward the end on the right, and the relationships between the change in the static pressure of the fluid and the change in the cross-sectional area of the nozzle are shown respectively.

TABLE 3

| | 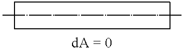 | 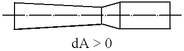 | 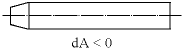 |
|---|---|---|---|
| M < 1 | $\frac{d p}{p} = 0$ | $\frac{dp}{p} = C \frac{dA}{A} ∴ \frac{dp}{dA} = C \frac{p}{A}$ | $\frac{dp}{p} = - C \frac{dA}{A} ∴ \frac{dV}{dA} = - C \frac{V}{A}$ |
| | NO CHANGE IN | INCREASE IN | DECREASE IN |
| | PRESSURE | PRESSURE | PRESSURE |
| M > 1 | INVALID | $\frac{dT}{T} = - C \frac{dA}{A} ∴ \frac{dT}{dA} = - C \frac{T}{A}$ | $\frac{dT}{T} = C \frac{dA}{A} ∴ \frac{dT}{dA} = C \frac{T}{A}$ |
| | | DECREASE IN | INCREASE IN |
| | | PRESSURE | PRESSURE |

The relationship between the change in the temperature of the fluid and the change in the area of the nozzle is as in the following Table 4. In Table 4, there is shown a straight nozzle on the left, a nozzle that broadens the diameter thereof toward the end in the middle, and nozzle that diminishes the diameter thereof toward the end on the right, and the relationships between the change in the temperature of the fluid and the change in the cross-sectional area of the nozzle are shown respectively.

TABLE 4

| | 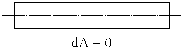 | 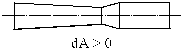 | 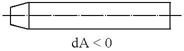 |
|---|---|---|---|
| M < 1 | $\frac{dT}{T} = 0$ | $\frac{dT}{T} = C \frac{dA}{A} ∴ \frac{dT}{dA} = C \frac{T}{A}$ | $\frac{dT}{T} = - C \frac{dA}{A} ∴ \frac{dT}{dA} = - C \frac{T}{A}$ |
| | NO CHANGE IN | INCREASE IN | DECREASE IN |
| | TEMPERATURE | TEMPERATURE | TEMPERATURE |
| M > 1 | INVALID | $\frac{dT}{T} = - C \frac{dA}{A} ∴ \frac{dT}{dA} = - C \frac{T}{A}$ | $\frac{dT}{T} = C \frac{dA}{A} ∴ \frac{dT}{dA} = C \frac{T}{A}$ |
| | | DECREASE IN | INCREASE IN |
| | | TEMPERATURE | TEMPERATURE |

Hereinafter is a summary of one-dimensional flow, assuming that the flow in the turbo nozzle is isoentropic flow. In this case, the velocity of the fluid flowing into the turbo nozzle is assumed to be subsonic, and the diameter of the nozzle at the inflow border and the outflow border are same. Therefore, the density prN of the fluid flowing into the turbo nozzle and the density POUT of the fluid discharged therefrom are assumed to be the same.

The relation of the mass flow rate at the inflow border and at the outflow border are theoretically expressed as follows.
m_{IN}=ρ_{IN}·A_{IN}·V_{IN}
m_{OUT}=ρ_{OUT}·A_{OUT}·V_{OUT}
ρ_{OUT}≦ρ_{IN′}A_{OUT}=A_{IN′}V_{OUT}≧V_{IN}
m_{IN}≈m_{OUT} (15)

However, since the flow in the turbo nozzle is not isoentropic flow, this is accompanied by a certain loss.

If the volumetric efficiency η_{T}_{_{B}} with respect to the turbo nozzle is applied to equation (15), the relation of the mass flow rate at the inflow border and at the outflow border becomes the following equation.
m_{IN}=η_{TB}·m_{OUT} (16)

Similarly in the straight nozzle, if the volumetric efficiency η_{ST} with respect to the straight nozzle is applied, the relation of the mass flow rate at the inflow border and at the outflow border becomes the following equation.
m_{IV}=η_{ST}·m_{OUT} (17)

The relationships of the volumetric efficiency η_{T}_{_{B}} with respect to the turbo nozzle and the volumetric efficiency η_{ST} with respect to the straight nozzle becomes the following equation.
η_{TB}>η_{ST} (18)

The reason why equation (18) is satisfied is that energy (heat quantity Q) is considered to be transferred from the surrounding medium (air) due to the rapid decrease in the temperature of the fluid flowing through the diffuser portion of the turbo nozzle.

That is, the entropy in the turbo nozzle is increased, and the energy loss in the diffuser portion is suppressed.

As a result, the transportation efficiency of the turbo nozzle is increased by 5 to 10% compared to for the straight nozzle.

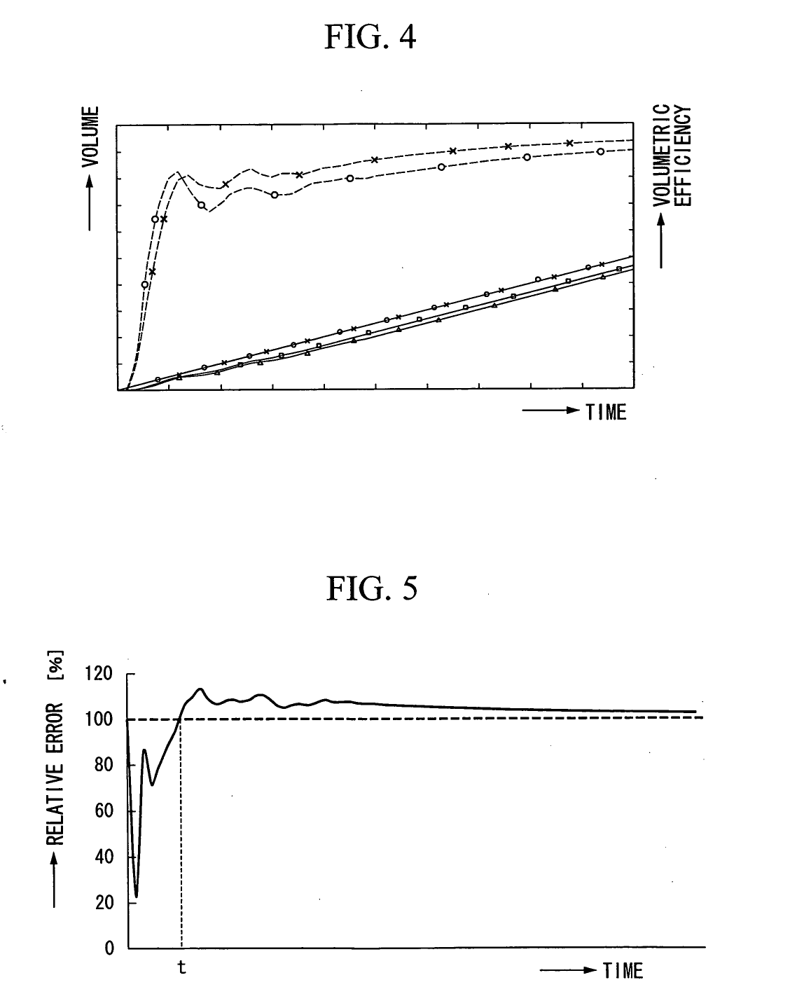

FIG. 4 shows the volume at the inflow border of the straight nozzle by a solid line with circles, the volume at the outflow border of the straight nozzle by a solid line with triangles, the volume at the inflow border of the turbo nozzle by a solid line with crosses, and the volume at the outflow border of the turbo nozzle by a solid line with squares. Moreover, FIG. 4 shows the volumetric efficiency of the straight nozzle by broken lines with circles, and the volumetric efficiency of the turbo nozzle by broken lines with crosses. From FIG. 4, it is also demonstrated that the relationships of the volumetric efficiency η_{T}_{_{B}} with respect to the turbo nozzle, and the volumetric efficiency η_{ST} with respect to the straight nozzle satisfy equation (18).

FIG. 5 shows the relative error of the turbo nozzle by a solid line, assuming that that of the straight nozzle is 100% as shown by the broken line. As is apparent from FIG. 5, the relative error of the turbo nozzle is less than 100% at the beginning of the inflation of the airbag, and then becomes slightly larger than 100% thereafter. Here, the phase until the point t where the relative error becomes 100% can be reduced by adjusting the minimum diameter of the throat portion.

While preferred embodiments of the invention have been described above, it should be understood that these are exemplary of the invention and are not to be considered as limiting. Additions, omissions, substitutions, and other modifications can be made without departing from the sprit or scope of the present invention. Accordingly, the invention is not to be considered as being limited by the foregoing description, and is only limited by the scope of the appended claims.

What is claimed is:

1. An airbag device comprising:
an inflator which generates a pressure by means of a fluid;
an airbag which expands by the pressure from said inflator; and
an inlet pipe which communicates between said inflator and said airbag,
wherein said inlet pipe comprises:
a straight portion having an approximately equal inner diameter;
a throat portion provided on the downstream side of said straight portion and having an inner diameter decreased towards the downstream; and
a diffuser portion provided on the downstream side of said throat portion and having an inner diameter increased towards the downstream so as to become approximately the same as the inner diameter of said straight portion.
